(19) United States
(12) Patent Application Publication
(10) Pub. No.: US 2019/0093853 A1
(43) Pub. Date: Mar. 28, 2019

(54) LIGHT GUIDE ASSEMBLY HAVING PHOSPHORESCENT MATERIAL

(71) Applicant: GM GLOBAL TECHNOLOGY OPERATIONS LLC, Detroit, MI (US)

(72) Inventors: Jonglee Park, Troy, MI (US); Jeffrey T. Zawacki, Oxford, MI (US)

(21) Appl. No.: 15/715,586

(22) Filed: Sep. 26, 2017

(51) Int. Cl. F21S 8/10; F21V 8/00

(52) U.S. Cl. CPC F21S 48/1241; G02B 6/0003; F21Y 2115/10; F21S 48/1131; F21S 48/1305; F21S 48/115

(57) ABSTRACT

An automotive vehicle includes a body having an exterior surface, a housing disposed on the exterior surface, a light source disposed in the housing, and a light guide optically coupled to the light source. The light source is configured to emit light with a first hue. The light guide has a receiving portion, an emitting portion, and a central portion disposed between the receiving portion and the emitting portion. The central portion is provided with a phosphorescent material such that light emitted at the emitting portion has a second hue, distinct from the first hue.

### TECHNICAL FIELD

The present disclosure relates to light assemblies, and more particularly to light assemblies for automotive vehicles.

### INTRODUCTION

Automotive vehicles may be provided with a plurality of light sources on exterior portions of the vehicle. Vehicles generally utilize a headlight to light an area in the vicinity of the vehicle. Other types of automotive lights may be functional, e.g. brake or turn signal lights, or stylistic. While halogen bulbs have traditionally been used as the light source for vehicle lights, recently LED lights have been implemented in some applications. LED lights provide various advantages in headlights relative to halogen bulbs, including relatively long lifespan and low power consumption.

### SUMMARY

A lighting assembly according to the present disclosure includes a light source and a housing retaining the light source. The lighting assembly also includes a light guide. The light guide is optically coupled to the light source to receive light emitted by the light source. The light guide has a first portion and a second portion. The light guide includes a phosphorescent material disposed between the first portion and second portion, such that light emitted at the first portion has a first hue and light emitted from at the second portion has a second hue, distinct from the first hue.

In an exemplary embodiment, the light source includes a colored LED. The colored LED may be a blue LED, and the phosphorescent material may be a yellow phosphor.

In an exemplary embodiment, the light assembly additionally includes an automotive vehicle having an exterior, where the light guide is disposed on the exterior.

In an exemplary embodiment, the light guide includes a polycarbonate, silicone, or acrylic material.

In an exemplary embodiment, the phosphorescent material forms a contiguous layer disposed between the first portion and the second portion. In such an embodiment, the phosphorescent material may also form a second contiguous layer spaced from the contiguous layer.

In an exemplary embodiment, the phosphorescent material includes a plurality of distinct portions disposed in the light guide.

In an exemplary embodiment, the lighting assembly additionally includes a reflector disposed proximate the light guide between the first portion and the second portion.

In an exemplary embodiment, the lighting assembly additionally includes a plurality of LED lights disposed along a length of the light guide.

An automotive vehicle according to the present disclosure includes a body having an exterior surface, a housing disposed on the exterior surface, a light source disposed in the housing, and a light guide optically coupled to the light source. The light source is configured to emit light with a first hue. The light guide has a receiving portion, an emitting portion, and a central portion disposed between the receiving portion and the emitting portion. The central portion is provided with a phosphorescent material such that light emitted at the emitting portion has a second hue, distinct from the first hue.

In an exemplary embodiment, the light source includes a colored LED. The colored LED may be a blue LED, and the phosphorescent material may be a yellow phosphor.

In an exemplary embodiment, the light assembly additionally includes an automotive vehicle having an exterior, where the light guide is disposed on the exterior.

In an exemplary embodiment, the light guide includes a polycarbonate, silicone, or acrylic material.

In an exemplary embodiment, the phosphorescent material forms a contiguous layer. In such an embodiment, the phosphorescent material may also form a second contiguous layer spaced from the contiguous layer.

In an exemplary embodiment, the phosphorescent material includes a plurality of distinct portions disposed in the light guide.

In an exemplary embodiment, the lighting assembly additionally includes a reflector disposed proximate the light guide between the first portion and the second portion.

In an exemplary embodiment, the lighting assembly additionally includes a plurality of LED lights disposed along a length of the light guide.

Embodiments according to the present disclosure provide a number of advantages. For example, systems and methods according to the present disclosure may provide multiple colors within a common light guide using a common light source, enabling various desirable styling effects and thereby increasing customer satisfaction.

The above advantage and other advantages and features of the present disclosure will be apparent from the following detailed description of the preferred embodiments when taken in connection with the accompanying drawings.

### BRIEF DESCRIPTION OF THE DRAWINGS

FIG. 1 is an illustration of a vehicle according to an embodiment of the present disclosure;

FIG. 2 is a schematic representation of a lighting assembly according to a first embodiment of the present disclosure;

FIG. 3 is a schematic representation of a lighting assembly according to a second embodiment of the present disclosure; and

FIG. 4 is a schematic representation of a lighting assembly according to a third embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

While LED lights provide various advantages relative to halogen bulbs as discussed above, one challenge is that LED lights do not inherently generate a white color. Known white LED lights generally consist of a colored LED chip, e.g. an indium gallium nitride (“InGaN”) blue LED, with a phosphor material, e.g. a yellow yttrium aluminum garnet (“YAG”) phosphor, applied as a coating on the chip. Such LEDs may be referred to as phosphor-converted white LEDs.

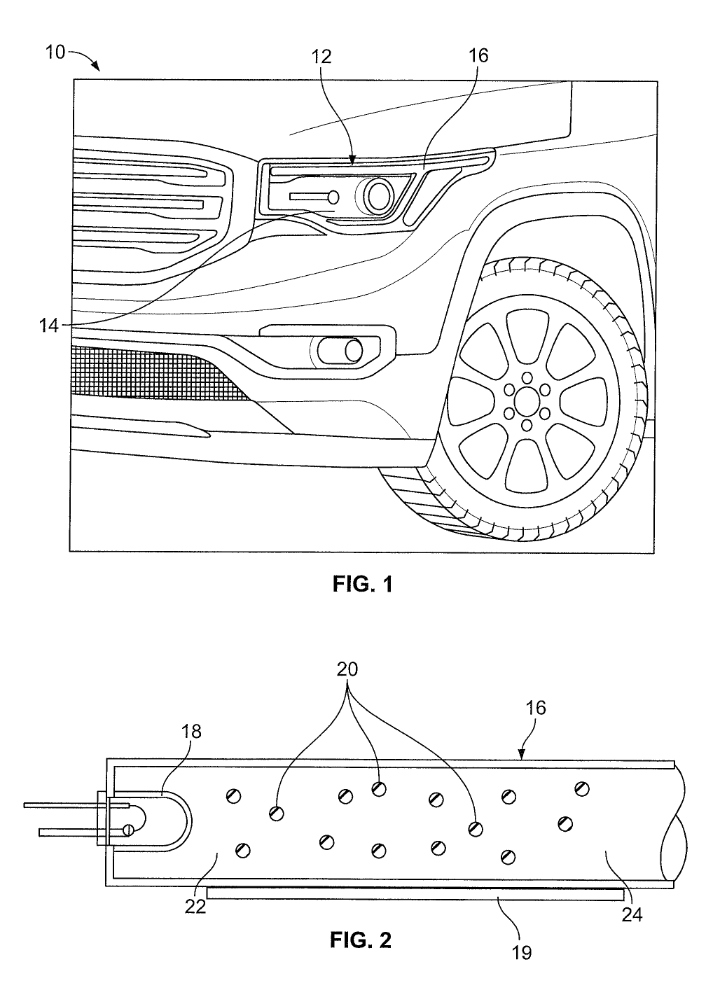

Referring now to FIGS. 1 and 2, an automotive vehicle 10 according to the present disclosure is illustrated. The automotive vehicle 10 is provided with a lighting assembly 12. In the embodiment illustrated in FIG. 1 the lighting assembly 12 is a stylistic accent light, which may be referred to as a signature light. However, in other embodiments considered within the scope of the present disclosure, the lighting assembly may include other lighting devices, such as functional lighting devices.

The lighting assembly 12 includes a housing 14 with a light guide 16 disposed therein. The light guide 16 is optically coupled to a light source 18. In an exemplary embodiment, the light source 18 includes one or more LED lights. However, in other embodiments, other light sources may be used. The light guide 16 is configured to receive and redirect light from the light source 18. In the embodiment illustrated in FIG. 2, the light source 18 is disposed inside the light guide 16. However, in other embodiments, the light source may be spaced from the light guide 16, e.g. in conjunction with a lens or reflector to direct light from the light source 18 into the light guide 16. In the embodiment illustrated in FIG. 2, the light guide 16 includes an elongate body configured to direct and diffuse light along the length of the elongate body. In such an embodiment, the light guide 16 may be protected by a lens. However, in other embodiments, the light guide may form at least a portion of a lens itself.

A reflector 19 is disposed along at least a portion of the light guide 16. The reflector 19 is arranged to reflect light from the light source 18 in a desired direction to enhance lighting output from the system. In an alternate embodiment, the light source 18 may be arranged along at least a portion of the light guide in addition to, or in place of, the reflector 19. In such an embodiment, the light source 18 may include a plurality of LED lights spaced along the length of the light guide 16.

The light guide 16 is formed of a generally rigid transparent or translucent material, e.g. acrylic, or polycarbonate, mixed or embedded with particles or quantum dots 20 of phosphor. In some embodiments, the light guide 16 may be formed of a more flexible material such as silicone, likewise mixed or embedded with particles or quantum dots of phosphor. As light emitted by the light source 18 passes through the particles 20, the wavelength of the light is modified. As a result, a first portion 22 of the light guide 16 has a different hue from a second portion 24 of the light guide 16. In an exemplary embodiment where the light source 18 includes a blue LED light and the particles 20 include a yellow phosphor, the first portion 22 may emit a blue hue while the second portion 24 emits a white hue. The distribution of particles 20 within the light guide 16 may control the rate of transition between hues.

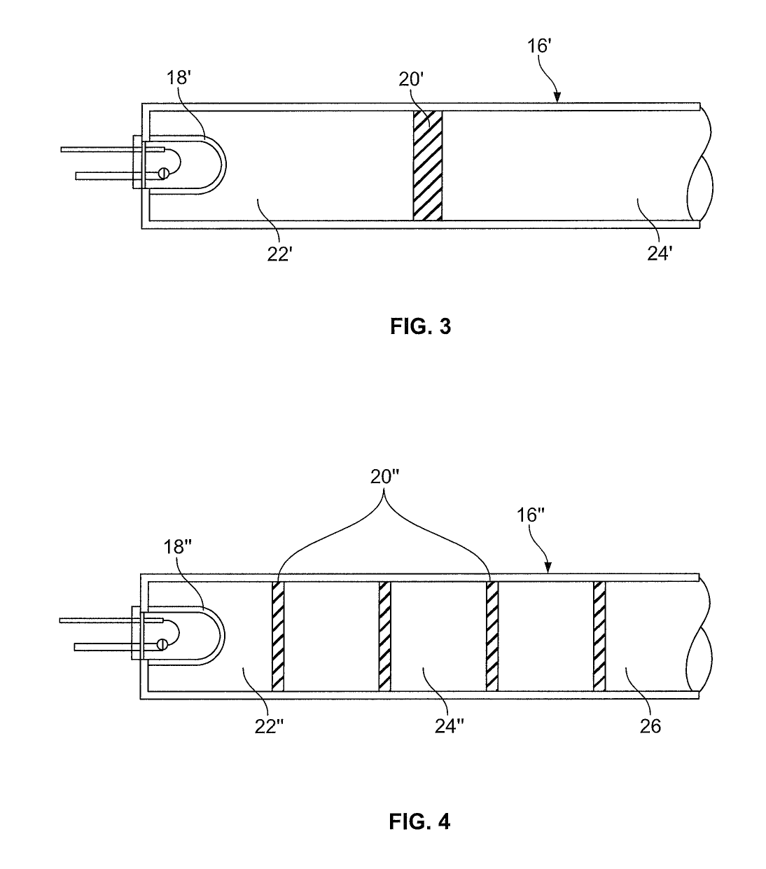

Referring now to FIG. 3, a second embodiment is illustrated. In this embodiment, a light guide 16′ is optically coupled to a light source 18′, generally as discussed above with respect to the embodiment illustrated in FIG. 2. The light guide 16′ is formed of a generally rigid transparent or translucent material, provided with a layer 20′ of phosphor. As light emitted by the light source 18′ passes through the layer 20′, the wavelength of the light is modified. As a result, a first portion 22′ of the light guide 16′ has a different hue from a second portion 24′ of the light guide 16′. Whereas the embodiment illustrated in FIG. 2 may provide a gradual rate of transition between different hues, the embodiment illustrated in FIG. 3 may provide a relatively stark contrast between the hue at the first portion 22′ and the hue of the second portion 24′.

In a variation of the embodiment of FIG. 3, the layer of phosphor may be disposed at a distal end of the light guide. In such an embodiment, the light guide may emit the first hue along its length, while emitting the second hue from the distal end.

Referring now to FIG. 4, a third embodiment is illustrated. In this embodiment, a light guide 16″ is optically coupled to a light source 18″, generally as discussed above with respect to the embodiment illustrated in FIG. 2. The light guide 16″ is formed of a generally rigid transparent or translucent material, provided with a plurality of layers 20″ of phosphor. As light emitted by the light source 18″ passes through the layers 20″, the wavelength of the light is modified. As a result, a first portion 22″ of the light guide 16″ has a different hue from a second portion 24″ of the light guide 16″, which in turn has a different hue from a third portion 26 of the light guide 16″. Whereas the embodiment illustrated in FIG. 2 may provide a gradual rate of transition between different hues, the embodiment illustrated in FIG. 3 may provide a stepped transition between the hue at the first portion 22″ and the hue of the third portion 26, with the hue of the second portion 24″ being an intermediate hue.

While the use of blue LED lights and yellow phosphor has been discussed above, other color combinations may be implemented in other embodiments. As non-limiting examples, a light source including a red LED light may be provided and the light guide may include a cyan phosphor, or a light source including a green LED light may be provided and the light guide may include a magenta phosphor. Such embodiments would result in light guides transitioning from red to white or from green to white, respectively. Other combinations are also contemplated within the scope of the present disclosure.

As discussed above, in some embodiments the light guide may form at least a portion of a lens for a lighting assembly, such as a headlamp lens. In such embodiments, phosphor may be embedded in the lens such that one portion of the lens emits white light, while another portion emits light of a different hue.

By providing the phosphor material within the light guide at locations remote from the light source, novel lighting effects may be achieved which are not feasible using conventional lighting devices with phosphor coatings applied to LED chips.

As may be seen, embodiments according to the present disclosure provides a system and method for producing multiple colors within a common light guide using a common light source, enabling various desirable styling effects and thereby increasing customer satisfaction.

As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

1. A lighting assembly comprising:
a light source;
a housing retaining the light source; and
a light guide being optically coupled to the light source to receive light emitted by the light source, the light guide comprising a body having a first portion and a second portion, wherein the light guide comprises a phosphorescent material disposed in the body between the first portion and second portion, such that light emitted at the first portion has a first hue and light emitted at the second portion has a second hue, distinct from the first hue.

2. The lighting assembly of claim 1, wherein the light source includes a colored LED.

3. The lighting assembly of claim 2, wherein the light source includes a blue LED and the phosphorescent material includes a yellow phosphor.

4. The light assembly of claim 1, further comprising an automotive vehicle having an exterior, wherein the light guide is disposed on the exterior.

5. The lighting assembly of claim 1, wherein the body comprises a polycarbonate, silicone, or acrylic material.

6. The lighting assembly of claim 1, wherein the phosphorescent material forms a contiguous layer in the body, the contiguous layer being disposed between the first portion and the second portion.

7. The lighting assembly of claim 6, wherein the phosphorescent material forms a second contiguous layer in the body, the second contiguous layer being spaced from the contiguous layer.

8. The lighting assembly of claim 1, wherein the phosphorescent material comprises a plurality of quantum dots disposed in the body.

9. The lighting assembly of claim 1, further comprising a reflector disposed proximate the light guide between the first portion and the second portion.

10. The lighting assembly of claim 1, wherein the light source includes a plurality of LED lights disposed along a length of the light guide.

11. An automotive vehicle comprising:
a vehicle body having an exterior surface;
a housing disposed on the exterior surface;
a light source disposed in the housing, the light source being configured to emit light with a first hue; and
a light guide optically coupled to the light source, the light guide having a light guide body with a receiving portion, an emitting portion, and a central portion disposed between the receiving portion and the emitting portion, wherein the central portion is provided with a phosphorescent material disposed within the body such that light emitted at the emitting portion has a second hue, distinct from the first hue.

12. The automotive vehicle of claim 11, wherein the light source includes a colored LED.

13. The automotive vehicle of claim 12, wherein the light source includes a blue LED and the phosphorescent material includes a yellow phosphor.

14. The automotive vehicle of claim 11, wherein the light guide body comprises a polycarbonate, silicone, or acrylic material.

15. The automotive vehicle of claim 11, wherein the phosphorescent material forms a contiguous layer in the light guide body.

16. The automotive vehicle of claim 15, wherein the phosphorescent material forms a second contiguous layer in the light guide body, the second contiguous layer being spaced from the contiguous layer.

17. The automotive vehicle of claim 11, wherein the phosphorescent material comprises a plurality of quantum dots disposed in the light guide body.

18. The automotive vehicle of claim 11, further comprising a reflector disposed proximate the central portion.

19. The automotive vehicle of claim 11, wherein the light source includes a plurality of LED lights disposed along a length of the light guide.
